(19) United States
(12) Patent Application Publication
(10) Pub. No.: US 2009/0097040 A1
(43) Pub. Date: Apr. 16, 2009

(54) Linear Motion Position Sensor and Method of Use

(75) Inventors: Phillip G. Robert, San Diego, CA (US); Peter S. Armstrong, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: SEQUAL TECHNOLOGIES, INC., San Diego, CA (US)

(21) Appl. No.: 12/250,094

(22) Filed: Oct. 13, 2008

Related U.S. Application Data
(60) Provisional application No. 60/979,944, filed on Oct. 15, 2007.

(51) Int. Cl. G01B 11/14

(52) U.S. Cl. 356/614

(57) ABSTRACT

A linear motion sensing system for sensing at least shaft position of a linear moving shaft of a linear motion device includes a sensed structure associated with and moving linearly in unison with the linear moving shaft; a light sensor assembly including a light emitter emitting light directed at the sensed structure and a light detector receiving light from the light emitter, the light sensor assembly emitting signals indicative of at least position of the sensed structure; and a sensor module receiving the signals indicative of at least position of the sensed structure from the light sensor assembly and determining at least shaft position of the linear moving shaft of the linear motion device.

### CROSS-REFERENCE TO RELATED APPLICATION

This application claims the benefit of provisional patent application 60/979,944, filed Oct. 15, 2007 under 35 U.S.C. 119(e). This provisional patent application is incorporated by reference herein as though set forth in full.

### FIELD OF THE INVENTION

The present invention relates to systems and method for sensing lineal changes of position in linear motors, especially linear motors of linear compressors.

### BACKGROUND OF THE INVENTION

Linear compressors include a piston moving back and forth along a linear path, and are usually driven by a linear motor. Linear motors are light and efficient, but when implemented in a linear compressor, control must be imposed to prevent compressor components from being driven to stops at either end of the linear displacement. Controlling the linear displacement requires sensors which preferably provide a linear output for efficient control of the linear motor. It is also preferable to avoid a burden of additional processing to convert a nonlinear output to a linear control signal.

A linear motor produces strong and variable magnetic fields, so any position sensing technology must be capable of operating effectively in such an environment. It is further preferable that the position sensing technology be economically viable for use in commercial products.

Conventional sensing methods include coupling a linear variable differential transformer (“LVDT”) instrument to the compressor shaft to sense linear changes in position. LVDT-based sensors tend to be relatively expensive, however. And, while they are reasonably immune to external magnetic fields, some effects due to such fields on the performance of LVDT-based sensors remain and must be compensated for with additional processing. Moreover, LVDT coils contribute to an undesirable increase in the external size of the compressor.

Improved methods and systems are therefore needed to address the problems in conventional linear motion sensing in a linear compressor.

### SUMMARY OF THE INVENTION

An aspect of the invention involves a linear motion sensing system for sensing at least shaft position of a linear moving shaft of a linear motion device. The linear motion sensing system includes a sensed structure associated with and moving linearly in unison with the linear moving shaft; a light sensor assembly including a light emitter emitting light directed at the sensed structure and a light detector receiving light from the light emitter, the light sensor assembly emitting signals indicative of at least position of the sensed structure; and a sensor module receiving the signals indicative of at least position of the sensed structure from the light sensor assembly and determining at least shaft position of the linear moving shaft of the linear motion device.

Another aspect of the invention involves a method of sensing at least shaft position of a linear moving shaft of a linear motion device including the linear motion sensing system described immediately above. The method includes sensing the sensed structure associated with and moving linearly in unison with the linear moving shaft with the light sensor assembly by emitting light directed at the sensed structure with the light emitter and receiving light from the light emitter with the light detector; emitting signals indicative of at least position of the sensed structure with the light sensor assembly; and determining at least shaft position of the linear moving shaft with the sensor module by receiving and processing the signals indicative of at least position of the sensed structure from the light sensor assembly.

### BRIEF DESCRIPTION OF THE DRAWINGS

FIG. 1A is a simple cross-sectional view of an embodiment of a linear compressor;

FIG. 1B is a block diagram of an embodiment of a linear motion sensing system for sensing at least shaft position of a linear moving shaft of a linear motion device;

FIG. 2 is a simple side-elevational view of an embodiment of a linear motion sensing system, and utilizes a LED, a bi-cell photodetector, and a reflective surface;

FIG. 3A is a simple side-elevational view of an embodiment of a sensed structure of a linear motion sensing system, the sensed structure including a blade with a linear ramp aperture;

FIG. 3B is a simple side-elevational view of another embodiment of a sensed structure of a linear motion sensing system, the sensed structure including a blade with a series of slot apertures;

FIG. 4 is a simple side-elevational view of an embodiment of a linear motion sensing system including grooves on a shaft, positioned within an emitter/detector housing;

FIG. 5A is another simple cross-sectional view of an embodiment of a linear motion sensing system including an example shaft and housing with light and detector ports;

FIG. 5B is a simple cross-sectional view of the linear motion sensing system of FIG. 5A, and shows the shaft and housing where light is passed to a detector port through bottom grooves;

FIG. 6A is a simple cross-sectional view of another embodiment of a linear motion sensing system including an example shaft and housing where light is passed or occulted to a detector port by grooves or lands on the shaft;

FIG. 6B is a perspective view of the linear motion sensing system in FIG. 6A and illustrates where two emitter/detector pairs are used to indicate direction of motion;

FIG. 7 depicts a graph of an exemplary detection signal produced by the embodiment of a linear motion sensing system shown in FIG. 5A; and

FIG. 8 depicts a graph of an exemplary quadrature signal produced by the linear motion sensing system shown in FIGS. 6A and 6B.

FIG. 9 is a block diagram illustrating an exemplary computer as may be used in connection with the system(s) to carry out the method(s) described herein.

### DETAILED DESCRIPTION OF EMBODIMENT OF INVENTION

With reference initially to FIG. 1A, before describing multiple embodiments of a linear motion sensing system, an example linear compressor 100 that the linear motion sensing systems may be used with will first be described. The linear compressor 100 includes a piston 110 coupled to a shaft 120, both of which move laterally/linearly in unison. In one example, the lateral motion is substantially ±0.250 inches. Two flat springs 130, 140 encircle the shaft 120, and a linear motor 150 drives the lateral motion of the shaft 120 and the piston 110. Conventionally, a socketed head cap screw (SHCS) 160 is coupled to the shaft 120 at one end as shown. Although the linear motion sensing systems will be described in conjunction with a linear compressor, in alternative embodiments, the linear motion sensing systems are used to sense the linear motion of structures of other linear motion devices other than a linear compressor.

With reference to FIG. 1B, an embodiment of a generic linear motion sensing system 165 for sensing at least shaft position of a linear moving shaft of a linear motion device will be described. The linear motion sensing system 165 includes a light sensor assembly 170 having a light emitter 175 that emits light at a sensed structure 180 associated with and moving linearly in unison with the linear moving shaft and a light detector 185 that receives light from the light emitter 175. Light received by the light detector 185 may have, for example, but not by way of limitation, reflected off of the sensed structure 180, been transmitted through the sensed structure 180, and/or been guided by the sensed structure 180. The light sensor assembly 170 emits signals indicative of at least position of the sensed structure 180. The emitter 175 and the detector 185 may include any of the emitters/detectors described explicitly or implicitly herein or other emitters/detectors not described herein. The sensed structure associated with and moving linearly in unison with the linear moving shaft may be any of the sensed structures described explicitly or implicitly herein or other sensed structures not described herein. The sensed structures may be integral with or not integral with the linear moving shaft. A sensor module 190 receives the signals indicative of at least position of the sensed structure from the light sensor assembly 170 and determines at least shaft position of the linear moving shaft of the linear motion device (e.g., linear compressor 100, linear motor 150).

In some embodiments shown and described herein, the light sensor assembly includes a first emitter and first detector (i.e., first emitter/detector set) and a second emitter and second detector (i.e., first emitter/detector set) that is positionally offset with respect to the first emitter and first detector in the linear direction of travel of the linear moving shaft. In other embodiments, other numbers of emitter/detector sets may be used (e.g., 3, 4, etc.) The emitters 175 emit light directed at the sensed structure 180 and the detectors 185 respectively receive light from the light emitters 175. The light sensor assembly 170 emits signals indicative of position of the sensed structure and direction of travel of the sensed structure, and the sensor module 190 receives the signals indicative of position of the sensed structure 180 and direction of travel of the sensed structure 180 and determine shaft position and direction of travel of the linear moving shaft of the linear motion device.

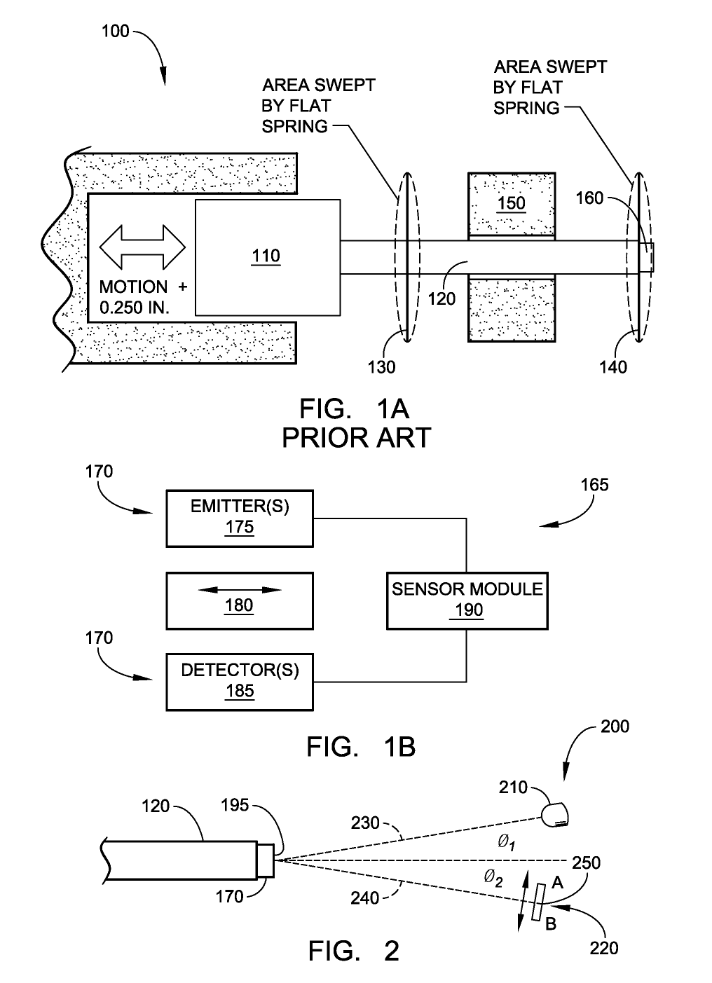

With reference to FIG. 2, in one embodiment, the SHCS 160 is replaced with a stud 170 with a polished, flat, reflective surface 195 on a face pointing away from the compressor 100. With reference additionally to FIG. 1B, the linear motion sensing system 200 includes a LED 210 as the light emitter 175 and a bi-cell photodetector 220 as the light detector 185 that together form part of the light sensor assembly 170 used to measure the position of the stud 170. Thus, the stud 170, and particularly the polished surface 195 of the stud 170, is the sensed structure 180 associated with and moving laterally/linearly in unison with the shaft 120. A light beam 230 is projected by the LED 210 onto the polished surface of the stud 170 where it is reflected (see beam 240) and received at the bi-cell photodetector 220. The bi-cell photodetector 220 includes two separate cells, cell A and cell B. As the stud moves toward the LED 210 and the detector 220, the angles of incidence and reflection, θ₁ and θ₂, increase such that the reflected spot moves away from a centerline 250, placing more of the spot upon detector B. As the stud 170 moves away from the LED 210 and the detector 220, θ₁ and θ₂ decrease and the spot moves toward the centerline 250 and therefore toward detector A. A sensor module (see, e.g., sensor module 190, FIG. 1B) determines at least shaft position of the linear moving shaft 120 based on the signals from the light sensor assembly and stored information based in part upon angles of incidence and reflection for the emitted and reflected light relative to reflective surface 195 for the signals from the light sensor assembly.

Advantages realized by the use of this embodiment include low cost while providing sufficient resolution for the LED 210 and the detector 220. Because it is based on light sensing, another advantage to this embodiment includes immunity to external magnetic fields produced by the linear motor. Additional length to the compressor 100 is required by the LED 210 and detector 220, however, and some components may require specialized coatings to minimize stray light and thereby increase the signal to noise ratio. The reflective surface 195 must be maintained as well, though this requirement is minimized when the sensor 200 is in a sealed environment and thus shielded from contaminants. Alignment of the LED 210 and bi-cell photodetector 220 must also be maintained to ensure that the reflection angles θ₁ and θ₂ are properly determined. The signal is also non-linear, typically requiring additional processing to linearize it.

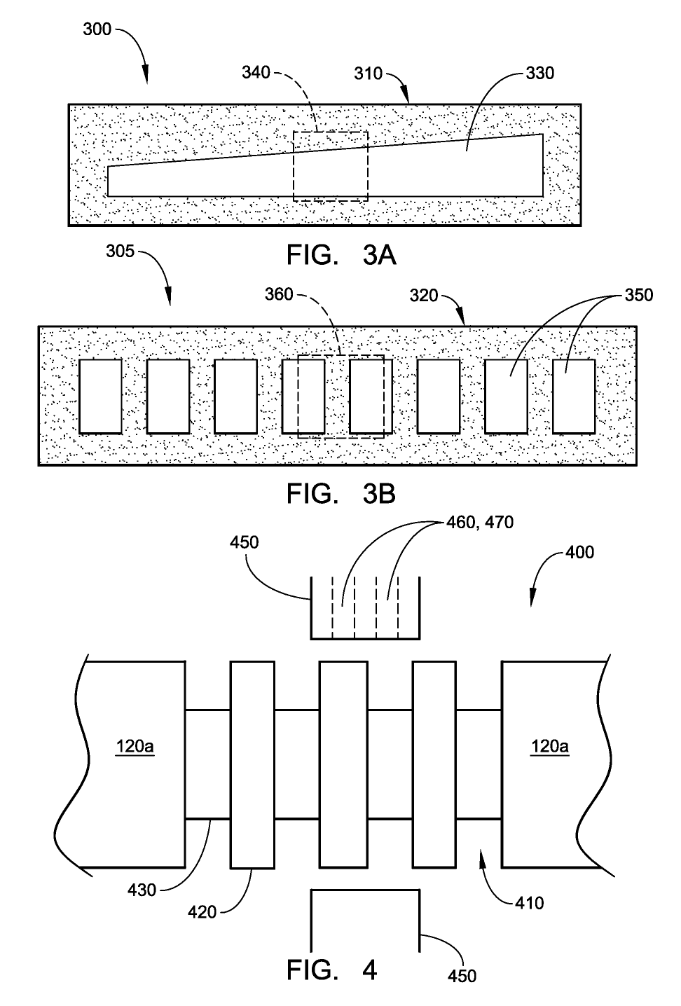

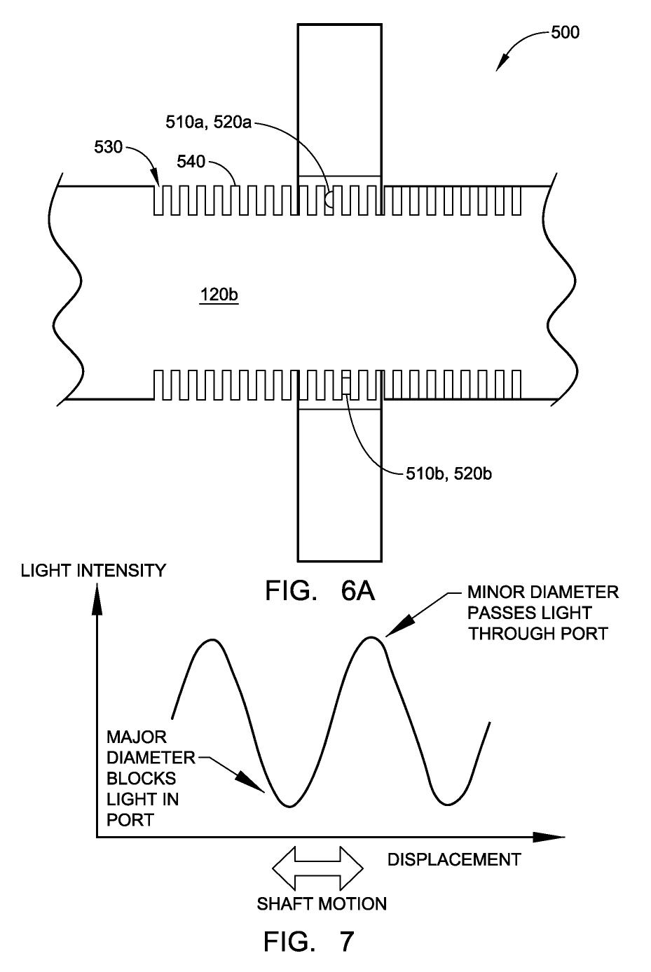

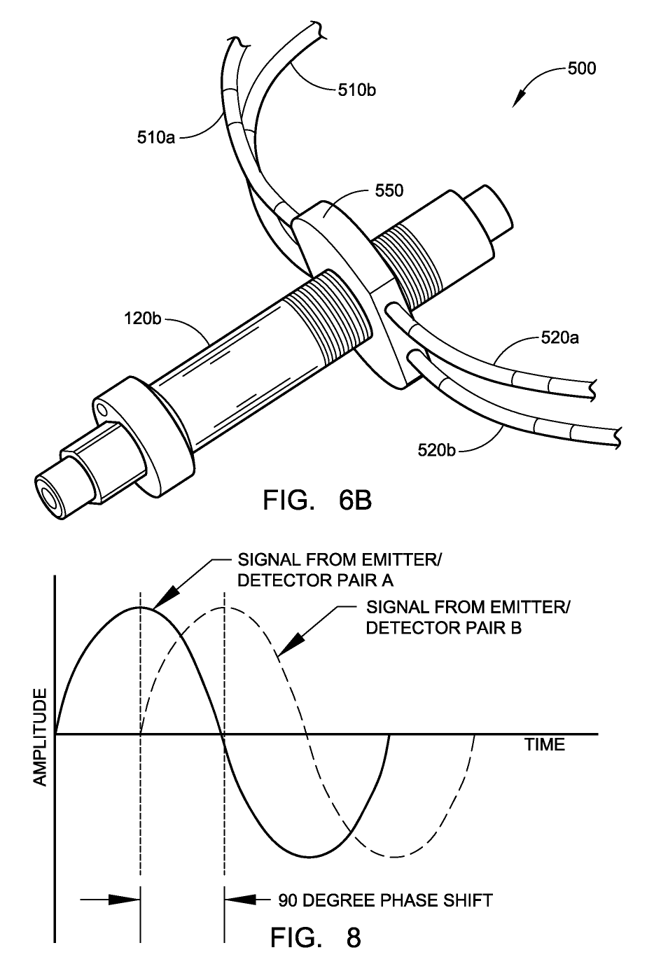

In another embodiment of a linear motion sensing system 300, referring to FIGS. 3A and 3B, a blade 310, 320 is attached to the end of the shaft 120. In this embodiment, the blade 310 is a sensed structure associated with and moving laterally/linearly in unison with the shaft 120. Thus, with reference additionally to FIG. 1B, the system 300 includes the blade 310 as the sensed structure 180, a light emitter 175, a light detector 185, and a sensor module 190. The blade 310 passes between the faces of an emitter/detector pair of optical components (See FIG. 6A, 6B for an example of an emitter/detector pair). In one implementation, as shown in FIG. 3A, the blade 310 may be cut with a ramp-shaped blade aperture 330. This produces a signal that is linear with respect to the lateral displacement of the shaft 120. As the blade 310 moves laterally/linearly, the light projected into, and received through, emitter/detector observation window 340 (by/from emitter 175/detector 185) increases or decreases linearly. Alternatively, the blade aperture 330 may be tailored to a shape optimizing sensing performance according a desired characteristic of the control system. A blade cut as provided by this embodiment provides theoretically infinite position resolution, subject to noise. It is therefore particularly effective with analog control techniques because no digital to analog conversion is required.

In another implementation of a linear motion sensing system 305, depicted in FIG. 3B, the blade 320 includes a series of slot apertures (“slots”) 350. The slots 350 translate between two emitters and two detectors oriented with emitter/detector observation window 360. The positions of the pairs of emitters and detectors and the slot sizes may be configured to produce a combined quadrature output. The quadrature output provides not only position information, but also information as to the direction of travel of the shaft. The arrangement of slots on the blade 320 may also function as a standard encoder. Thus, with reference additionally to FIG. 1B, the system 305 includes the blade 320 as the sensed structure 180, a light emitter 175, a light detector 185, and a sensor module 190.

Emitters and detectors are relatively inexpensive, making blade implementations sufficiently economical for commercial use. However, length is typically added to the compressor, similarly to the previous embodiment utilizing an LED and bi-cell photodetector. Also, the moving mass of the compressor shaft is increased, which may require more power of the linear motor and/or change its control characteristics.

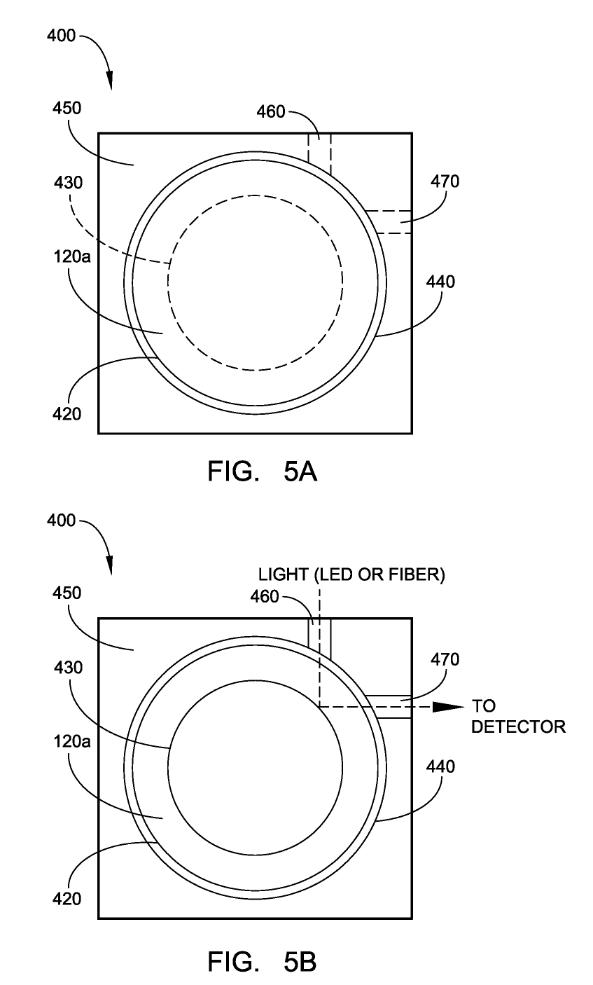

In another embodiment of a linear motion sensing system 400, referring to FIGS. 4, 5A, and 5B, the shaft 120a includes one or more features or structures. In one example, the shaft 120a has one or more square bottom grooves 410, characterized by major and minor diameters 420, 430. It will be appreciated that the bottom grooves 410 may have other characteristics than squareness. The shaft 120a passes through a bore 440 in an emitter/detector housing (“housing”) 450. As shown in FIGS. 5A and 5B, the bore 440 of the housing 450 is slightly larger in diameter than the shaft 120 (i.e., major diameter 420), such that while the shaft 12a does not contact the wall forming the bore 440 as the shaft 120a moves back and forth, a substantially close fit is still attained. Emitter/detector ports 460, 470 with respective emitter(s)/detector(s) are arranged as shown in FIGS. 5A and 5B, typically perpendicular with respect to the longitudinal axis of the shaft 120a.

The housing 450 and longitudinal section of the shaft 120a in which the grooves 410 are cut are positioned relatively such that grooves 410 are substantially aligned with the emitter/detector ports 460, 470 at any given lateral displacement of the shaft. Thus, as the shaft 120a moves back and forth in the housing 450, the grooves 410 on the shaft 120a will pass light through to detector ports 470. As depicted in FIG. 5B, an emitter/detector port 460 functioning as a “light port” allows a light emitter (e.g., LED or fiber) to shine into the bore 440 perpendicularly to the axis of the shaft 120a. The light fills the volume of the groove, and the detector port 470 allows the light to shine out of the bore 440 to the light detector. Light from the light emitter therefore passes through to the detector port 470 to the light detector only when a groove 410 (i.e., a minor diameter 430) is aligned with the light and detector ports 460, 470. Otherwise, as shown in FIG. 5A, the shaft 120a is at a lateral position such that a major diameter 420 between two grooves 410 blocks the light port, or at a position in which the light is partially blocked. Thus, with reference additionally to FIG. 1B, the system 400 includes the grooves 410 as the sensed structure 180, light emitter(s) 175, light detector(s) 185, and a sensor module 190.

FIG. 7 illustrates the sinusoidal nature of the signal obtained through the detector port 470 as a function of shaft displacement using the linear motion sensing system 400 of FIGS. 5A and 5B. The light intensity is at a minimum when a section of the shaft 120a characterized by the major diameter 420 blocks an emitter/detector port pair 460, 470. The light intensity is at a maximum when a section of the shaft at a groove 410 (characterized by the minor diameter 430) aligns with an emitter/detector port pair 460, 470, allowing light to be passed to the detector port, as shown in FIG. 5B.

An alternate embodiment of a linear motion sensing system 500 is shown in FIGS. 6A and 6B where rather than relying on light filling a groove 410 in a shaft 120b passing through a housing 450, light passes directly from an emitter 510a, b to a detector 520a, b through aperture slot 530. When a major diameter 540 of the shaft 120b blocks the direct path between the emitter 510a, b and detector 520a, b, no light (or minimal light) is received at the detector 520. The emitter(s) 510a, b and the detector(s) 520a, b are carried by emitter/detector holder 550, which the slotted shaft 120 reciprocates through. Thus, with reference additionally to FIG. 1B, the system 500 includes the aperture slots 530 as the sensed structure 180, the emitters 510a, b as light emitters 175, the light detectors 520a, b as light detector(s) 185, and a sensor module 190.

In the linear motion sensing system 500 shown in FIGS. 6A and 6B, and particularly FIG. 6A, two sets of ports (i.e., first set 510a, 520a, second set 510b, 520b) positioned 900 out of phase generate a normal quadrature encoded signal pair. The quadrature information allows not only the shaft position to be determined, but also the lateral direction in which the shaft 120b is moving. FIG. 8 depicts a graph of an exemplary quadrature signal produced by the linear motion sensing system 500 shown in FIGS. 6A and 6B.

Advantages realized by the linear motion sensing systems 400, 500 include improved sensitivity to small changes in the motor or compressor states controlling the position of the shaft, and significant cost savings. Further, the overall length of the linear compressor 100 is not increased. An implementation utilizing fiber optics is further immune to any magnetic fields produced by the compressor 100. The output signal (see FIG. 7) is easily conditioned for use as an encoder input.

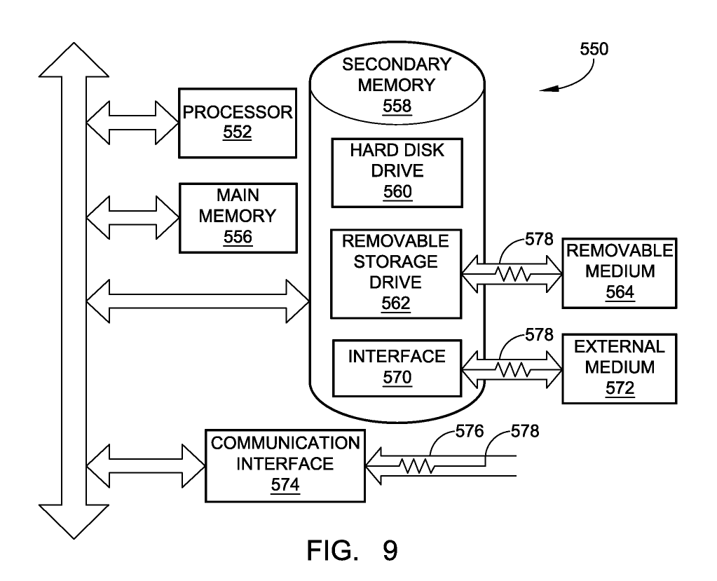

FIG. 9 is a block diagram illustrating an exemplary computer 550 that may be used in connection with the various embodiments described herein. However, other computers and/or architectures may be used, as will be clear to those skilled in the art.

The computer 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer 550 as electrical communication signals 578.

In alternative embodiments, secondary memory 558 may include other similar means for allowing computer programs or other data or instructions to be loaded into the computer 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer 550.

Computer 550 may also include a communication interface 574. The communication interface 574 allows software and data to be transferred between computer system 550 and external devices (e.g. technician diagnostic laptops), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module (e.g., sensor module 190) executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A linear motion sensing system for sensing at least shaft position of a linear moving shaft of a linear motion device, the linear motion sensing system comprising:
a sensed structure associated with and moving linearly in unison with the linear moving shaft;
a light sensor assembly including a light emitter emitting light directed at the sensed structure and a light detector receiving light from the light emitter, the light sensor assembly emitting signals indicative of at least position of the sensed structure; and
a sensor module receiving the signals indicative of at least position of the sensed structure from the light sensor assembly and determining at least shaft position of the linear moving shaft of the linear motion device.

2. The system of claim 1, wherein the linear moving shaft is a shaft of a linear compressor.

3. The system of claim 1, wherein the linear moving shaft is a shaft controlled by a linear motor.

4. The system of claim 1, wherein the sensed structure is integral with the shaft.

5. The system of claim 1, wherein the sensed structure is not integral with the shaft.

6. The system of claim 1, wherein the sensed structure is a reflective surface.

7. The system of claim 6, wherein the light detector is a bi-cell photodetector that receives reflected light off the reflective surface and emits signals corresponding to where the reflected light is received on the bi-cell photodetector, and the sensor module determines at least shaft position of the linear moving shaft based on the signals from the light sensor assembly and stored information based in part upon angles of incidence and reflection for the emitted and reflected light relative to reflective surface for the signals from the light sensor assembly.

8. The system of claim 1, wherein the sensed structure is a blade including one or more apertures, and the light sensor assembly transmitting light to and through the one or more apertures of the blade, and emitting signals that are linear with respect to the lateral displacement of blade.

9. The system of claim 1, wherein the sensed structure includes one or more grooves in the shaft that form one or more light paths for transmitting light from the light emitter to the light detector.

10. The system of claim 1, wherein the sensed structure includes one or more aperture slots and the light emitter assembly includes the light emitter and the light detector opposite of each other, and the one or more aperture slots allow light to be transmitted from the light emitter through the one or more aperture slots to the light detector.

11. The system of claim 1, wherein the light sensor assembly includes a first emitter and first detector and a second emitter and second detector that is positionally offset with respect to the first emitter and first detector in the linear direction of travel of the linear moving shaft, and the emitters emitting light directed at the sensed structure and the detectors respectively receiving light from the light emitters, the light sensor assembly emitting signals indicative of position of the sensed structure and direction of travel of the sensed structure, and the sensor module receiving the signals indicative of position of the sensed structure and direction of travel of the sensed structure and determining shaft position and direction of travel of the linear moving shaft of the linear motion device.

12. A method of sensing at least shaft position of a linear moving shaft of a linear motion device including the linear motion sensing system of claim 1, the method comprising:
sensing the sensed structure associated with and moving linearly in unison with the linear moving shaft with the light sensor assembly by emitting light directed at the sensed structure with the light emitter and receiving light from the light emitter with the light detector;
emitting signals indicative of at least position of the sensed structure with the light sensor assembly; and
determining at least shaft position of the linear moving shaft with the sensor module by receiving and processing the signals indicative of at least position of the sensed structure from the light sensor assembly.

13. The method of claim 12, wherein the sensed structure is a reflective surface, and sensing includes receiving reflected light off the reflective surface.

14. The method of claim 13, wherein the light detector is a bi-cell photodetector, sensing includes receiving reflected light off the reflective surface and onto the bi-cell photodetector, emitting signals includes emitting signals corresponding to where the reflected light is received on the bi-cell photodetector, and determining includes determining at least shaft position of the linear moving shaft based on the signals from the light sensor assembly and stored information based in part upon angles of incidence and reflection for the emitted and reflected light relative to reflective surface for the signals from the light sensor assembly.

15. The method of claim 12, wherein the sensed structure is a blade including one or more apertures, and sensing includes the light sensor assembly transmitting light to and through the one or more apertures of the blade, and emitting signals includes emitting signals that are linear with respect to the lateral displacement of blade.

16. The method of claim 12, wherein the sensed structure includes one or more grooves in the shaft that form one or more light paths for transmitting light from the light emitter to the light detector, and sensing includes transmitting light from the light emitter to the light detector through the one or more light paths.

17. The method of claim 12, wherein the sensed structure includes one or more aperture slots and the light emitter assembly includes the light emitter and the light detector opposite of each other, and sensing includes transmitting light from the light emitter to the light detector through the one or more aperture slots.

18. The method of claim 12, wherein the light sensor assembly includes a first emitter and first detector and a second emitter and second detector that is positionally offset with respect to the first emitter and first detector in the linear direction of travel of the linear moving shaft, sensing includes emitting light by the emitters directed at the sensed structure and the detectors respectively receiving light from the light emitters, emitting signals includes emitting signals by the light sensor assembly indicative of position of the sensed structure and direction of travel of the sensed structure, and determining shaft position and direction of travel of the linear moving shaft with the sensor module by receiving and processing the signals indicative of position of the sensed structure and direction of travel of the sensed structure.
